(19) United States
(12) Patent Application Publication
(10) Pub. No.: US 2010/0088063 A1
(43) Pub. Date: Apr. 8, 2010

(54) Method and Apparatus for Precision Azimuth Measurement

(75) Inventor: Darren R. Laughlin, Albuquerque, NM (US)

Correspondence Address: PEACOCK MYERS, P.C., 201 THIRD STREET, N.W., SUITE 1340, ALBUQUERQUE, NM, 87102, US

(73) Assignee: A-TECH CORPORATION, Albuquerque, NM (US)

(21) Appl. No.: 12/572,181

(22) Filed: Oct. 1, 2009

Related U.S. Application Data
(60) Provisional application No. 61/101,870, filed on Oct. 1, 2008.

(51) Int. Cl. G06F 15/00; G01B 1/00

(52) U.S. Cl. 702/151; 33/300

(57) ABSTRACT

Method and apparatus for precise measurement of azimuth. An angular rate sensor is rotated so its sensitive axis periodically aligns with the horizontal component of the earth's spin rate (north). A preferably sinusoidal signal is analyzed with respect to the relative angle of the sensor and a desired direction in order to determine the azimuth of that direction.

### CROSS-REFERENCE TO RELATED APPLICATIONS

This application claims the benefit of the filing of U.S. Provisional Patent Application Ser. No. 61/101,870, entitled “Method and Apparatus for Precision Azimuth Measurement”, filed on Oct. 1, 2008, the specification of which is incorporated herein by reference.

### BACKGROUND OF THE INVENTION

1. Field of the Invention (Technical Field)

The present invention relates to precision measurement of azimuth, or the horizontal angle from True North which is the vector associated with the rotational spin axis of the Earth.

2. Background Art

Note that the following discussion refers to a number of publications and references. Discussion of such publications herein is given for more complete background of the scientific principles and is not to be construed as an admission that such publications are prior art for patentability determination purposes.

Precision and repeatable azimuth measurement is generally accepted to be significantly more difficult to measure than the Earth's spin vector direction in elevation. There are established, reliable methodologies to determine elevation based on the gravity vector, i.e. a triad of precision accelerometers, precision bubble tiltmeters or inclinometers can be used to accurately and reliably measure elevation angle. Azimuth is a mathematical concept defined as the angle, usually measured in degrees between a reference plane and a point. The azimuth referred to herein is the horizontal angle from True North (i.e. the vector associated with the rotational spin axis of the Earth) with respect to the horizon, as shown in FIG. 1. Accurate azimuth knowledge is crucial for navigation, astronomy, mapping, mining and artillery. There are a number of known methods for measuring azimuth, but each such method has critical disadvantages. Such methods include the following.

### Earth's Magnetic Field

Azimuth measurement to within certain accuracy bounds can be accomplished with a precision magnetometer, or compass, that is based on the Earth's magnetic field. However magnetic North based on the declination of the Earth's magnetic field can be very problematic. Any deflections in the local magnetic fields produce static error in the magnetic compass reading. Any ferrous material or electronic device can potentially deflect the local magnetic field producing erroneous azimuth measurements. Even the highest accuracy digital magnetic compasses (DMCs) are only accurate to about 10 milliradians and require frequent, time consuming, and relatively elaborate calibration processes. If fact, magnetometers are unusable in many critical applications where a few milliradians to sub-milliradian azimuth (bearing, heading, LOS angle) knowledge is required. One such critical application is in the battlefield where heavy artillery and vehicles made of ferrous steel inevitably corrupt magnetic compass readings. The necessary frequent recalibration of magnetic-based north finders is problematic and not always reliable. In addition, north finding based on magnetic compassing do not work very well inside most manmade structures where the Earth's weak magnetic field (0.3 to 0.6 gauss) is easily perturbed by ferrous materials (rebar, steel framing, steel railings, etc.), electrical power circuits, and equipment typically used in buildings.

### Gyro-Compassing

North Finding Modules (NFMs) and North seeking Modules (NSMs), which also depend on the Earth's rotation vector to measure True North, typically use precision mechanical or optical gyroscopes to determine azimuth. This type of azimuth measurement is generally referred to as gyro-compassing. Most of the gyro-based NSMs use a 4-point or “tumble” test to cancel scale factor and bias effects in determining the angle from north (azimuth). Although gyro-compassing is an accepted method of azimuth determination, these systems are very expensive, and are relatively large and heavy because of the type of gyro required. In addition, gyro-based azimuth measurement systems require several minutes to acquire azimuth measurements to the milliradian accuracy regime. Precision gyro-based azimuth measurement systems exist for surveying purposes, but are very expensive, large, and heavy.

### Differential GPS

Differential GPS (Global Positioning System) is another methodology for azimuth determination. The basic problem, especially for battlefield scenario, is that GPS is not available and can be jammed. GPS denied locations, i.e. inside buildings, underground tunnels and mines, urban and in proximity of natural and man made obstructions further complicates its usage. Another disadvantage of using GPS is that a separation distance between multiple GPS receivers of several meters is required to achieve sufficient accuracy. Also, many of these systems are large, typically require a tripod mount that is rotated to determine azimuth and take several minutes to yield high accuracy azimuth data.

### Celestial Body

Determination of azimuth and elevation by the sight angles to a celestial body (i.e., Polaris) has similar problems to the differential GPS solution by virtue of required access to the sky, where again weather conditions, clouds, dust, other natural and man made obstructions can interfere with the measurement. Together with the fact that it is difficult to see stars during the day, these disadvantages limit the usefulness of this approach. In addition, the sighting equipment needed (survey grade) is extremely heavy and not very man portable.

### SUMMARY OF THE INVENTION

### Disclosure of the Invention

The present invention is an apparatus for measuring azimuth, the apparatus comprising an angular rate sensor disposed on a turntable and a data collector for collecting an output from the angular rate sensor while the turntable is rotating. The sensitive axis of the angular rate sensor is preferably substantially parallel to the plane of rotation. The turntable preferably rotates at a substantially constant rotation rate. The rotation rate is preferably between approximately 0.5 Hz and approximately 30 Hz. The turntable preferably comprises an encoder for providing an angle of rotation of the turntable relative to a turntable base. The size of the apparatus is preferably less than approximately 200 cc, and more preferably less than approximately 150 cc. The weight of the apparatus is preferably less than approximately 1 kg, more preferably less than approximately 500 g, and even more preferably less than approximately 250 g. The apparatus optionally comprises two or more angular rate sensors. The turntable is preferably oriented so that its plane of rotation is approximately normal to a gravity vector or its axis of rotation is parallel to a gravity vector.

The present invention is also a method for detecting azimuth, the method comprising the steps of selecting a zero angle of a turntable to be coincident with a desired direction, rotating an angular rate sensor on the turntable, collecting an output signal from the sensor while the sensor is rotating, measuring an angle of rotation of the turntable relative to the zero angle; and calculating the azimuth of the desired direction. The rotating step preferably comprises rotating the angular rate sensor at a substantially constant rotation rate. The rotation rate is preferably between approximately 0.5 Hz and approximately 30 Hz. The calculating step optionally comprises correlating the angle of rotation to a characteristic of the output signal, wherein the characteristic is preferably selected from the group consisting of phase, maximum, minimum and zero crossing point. The method preferably further comprises the step of applying a bandpass filter to the output signal prior to detecting the zero crossing points, wherein the bandpass filter cutoff frequency is preferably approximately a rotation rate of the turntable. The calculating step optionally comprises applying a Fast Fourier Transform to the output signal. The rotating step optionally comprises rotating the angular rate sensor clockwise at a constant rotation rate and counterclockwise at the same constant rotation rate, in which case the clockwise output signal phase is preferably added to a counterclockwise output signal phase. Azimuth of the desired direction is preferably detected with an accuracy of less than approximately 1 mrad in less than approximately one minute from beginning the rotating step, and more preferably with an accuracy of less than approximately 0.1 mrad in less than approximately one minute from beginning the rotating step.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 shows how azimuth is measured.

FIG. 2 depicts a magneto-hydrodynamic angular rate sensor (ARS).

FIG. 3 shows an ARS-14 and ARS-15.

FIG. 4 depicts an embodiment of the present invention for azimuth measurement.

FIG. 5 depicts the basic operation of an embodiment of the present invention over one cycle of rotation.

FIGS. 6A-6B show typical frequency (magnitude and phase) response models for the ARS-14.

FIGS. 6C-6D show typical frequency (magnitude and phase) response models for the ARS-15.

FIG. 7 illustrates angular rate noise power spectral densities (PSD) for the ARS-14 and ARS-15 compared to the modulated earth rate PSD.

FIG. 8 plots simulated ARS-14 and ARS-15 sensor output signals scaled to angular rate overlaid on the horizontal Earth rate signal, or “ground truth”, for comparison.

FIG. 9A shows the Earth rate induced signal component at a 20 Hz turntable rotation rate with respect to the Equivalent Rate Noise PSD of the ARS-15 and the ARS-14.

FIG. 9B shows the RMS rate cumulative power forward sum which emphasizes the contribution of the Earth rate signal at 20 Hz.

FIG. 10A shows simulated full-bandwidth and band-pass filtered earth rate signals for the ARS-14.

FIG. 10B shows simulated full-bandwidth and band-pass filtered earth rate signals for the ARS-15.

FIG. 11 shows magnitude and phase of a digital band-pass filter (BPF) at the turntable spin frequency (2 Hz) that may be used to preprocess the ARS simulated output signal prior to zero cross detection.

FIG. 12 shows zero crossing results for simulated ARS-14 and ARS-15 signals which are band-pass filtered at 2 Hz.

FIG. 13 shows estimated azimuth measurement error versus acquisition time based on the ARS-14 and ARS-15 simulated outputs at a 2 Hz spin rate.

FIG. 14 is a photograph of a prototype embodiment of the present invention comprising two back-to-back ARS-14 MHD sensors.

FIG. 15A is the simulated ARS-14 signal scaled to angular rate with the Earth rate signal superimposed for a 2 Hz turntable rate.

FIG. 15B plots the measured ARS-14 voltage output signals with the turntable spin rate at 2 Hz for the prototype of FIG. 14.

FIG. 16 shows the digital bandpass filter that was used to preprocess the ARS-14 signals prior to Zero Cross Phase Detection for the prototype of FIG. 14.

FIG. 17A shows an ARS-14 signal before (blue) and after (green) the 2 Hz bandpass filter.

FIG. 17B shows the back to back ARS-14s signals after band-pass filtering.

FIG. 18A shows the rate PSD before filtering (blue curve) and after filtering (green curve) with the digital bandpass filter of FIG. 16.

FIG. 18B shows the cumulative forward sum (power) that illustrates the Earth rate signal contribution with respect to the background noise for an ARS-14.

FIG. 19A shows the Zero Cross Detection results using the prototype ARS-14 signal after 2 Hz bandpass filtering according to FIG. 16.

FIG. 19B depicts the relative azimuth error via averaging the zero cross times for both positive slope zero crossings (green curve) and negative slope zero cross (blue curve).

FIG. 20A shows the azimuth phase error using the FFT Phase Detection algorithm of the two ARS-14 units used in the prototype.

FIG. 20B shows the simulated predictions of azimuth error for the ARS-14 and the ARS-15.

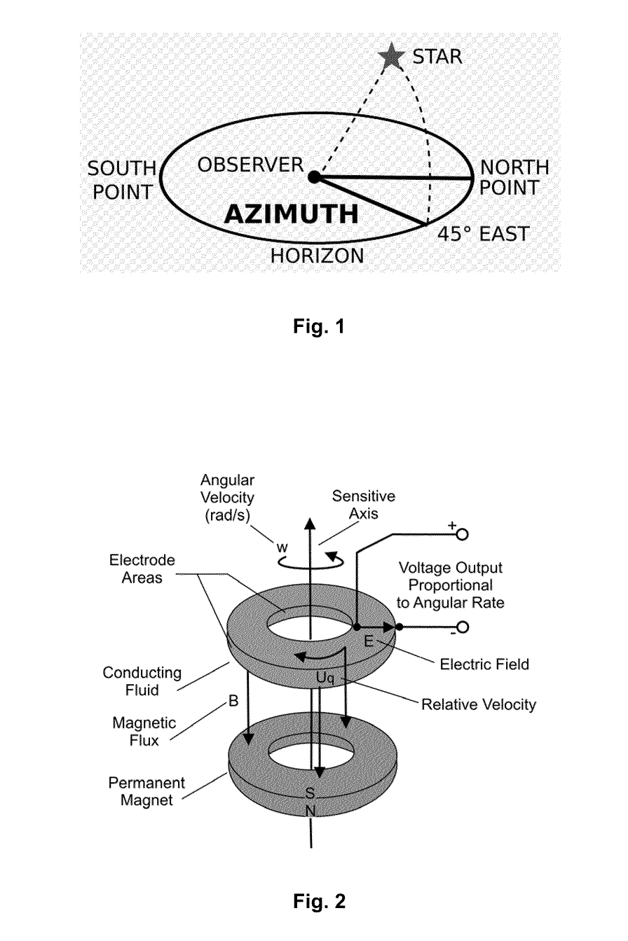

### DESCRIPTION OF THE PREFERRED EMBODIMENTS

### Best Modes for Carrying Out the Invention

The present invention preferably comprises a non-magnetic field, non-gyroscopic, non-celestial, and non-differential GPS-based azimuth measurement solution which does not depend on magnetic north and is insensitive to static and time varying magnetic fields associated with, for example, a battlefield environment. The present invention preferably utilizes inertial active rate sensing methods and apparatuses based on magneto-hydrodynamic (MHD) principles, as more fully described in commonly owned U.S. Pat. Nos. 6,173,611 and 4,718,276, which are incorporated herein by reference.

The general principle of operation of an MHD Angular Rate Sensor (ARS) is preferably based on using a conductive fluid constrained in a void free annulus with a static magnetic field applied through the conductive fluid, as shown in FIG. 2. The static magnetic field is preferably produced via permanent magnets. As the sensor is rotated about the sensitive axis (cylindrical axis) a relative velocity difference occurs between the conductive fluid and the magnetic field that moves with the case. This produces a voltage proportional to the relative circumferential velocity difference between the conductive fluid, the strength of the applied magnetic field, and the width of the sense channel. The rate proportional output voltage can then be either picked off directly, or input to a high gain internal transformer that amplifies the sense channel output voltage by several thousand times proportional to the transformer primary to secondary winding turn ratio. A low noise op-amp is typically the only additional electronics required to amplify the signal, which is subsequently preferably digitized using a high resolution Analog to Digital Converter (ADC) up to 24 bits. Use of very high bit resolution ADCs is preferred to take full advantage of the MHD ARS' large dynamic range. As used throughout the specification and claims, the term “angular rate sensor” or “ARS” means any north sensing device that does not utilize one or more gyroscopes, the earth's magnetic field, celestial bodies, or GPS, including but not limited to magneto-hydrodynamic devices.

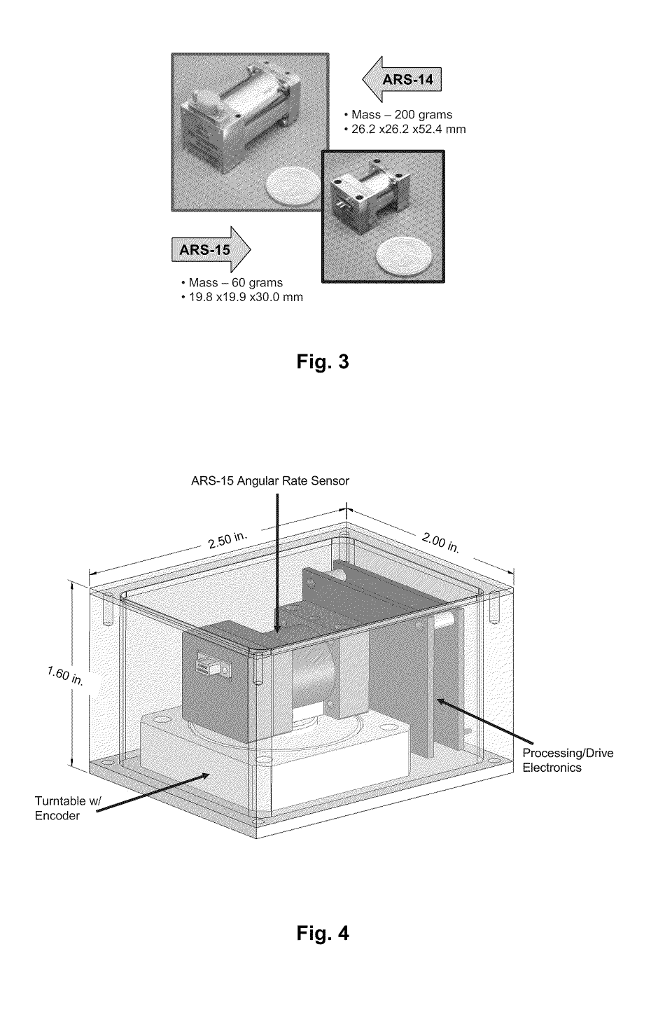

FIG. 3 shows two MHD ARS products applicable to azimuth measurement: the ARS-14 and the ARS-15. The size of these units is very small; for example, the ARS-15 model weighs about 60 grams and has a volume of less than 1 cubic inch. MHD ARS features include: very scalable to measure ultra-low to ultra-high angular rates, very high dynamic range (typically 130+ dB), and very low noise, e.g. ARS-14: 40 nrad, 1-2000 Hz and ARS-15: 500 nrad, 1-2000 Hz, low linear & cross-axis sensitivity, low power, very long operating life, standard −40 to 65° C. operating temp, optionally down to −60° C., and a frequency response of 0.2 to 1000+Hz. MHD ARS applications include angular rate measurement, North Seeking/Finding Modules, vibration/jitter measurement, precision pointing and tracking, (optical) inertial sensing/inertial measurement units (IMUs), inertial reference units (IRUs), line of sight (LOS) stabilization (e.g. for imaging systems), satellite attitude determination, aerospace system vibration monitoring, test and evaluation, and north seeking/finding azimuth measurement, and other measurement and control applications. Unlike a gyro, an MHD ARS cannot measure a static (constant) angular rate; it typically measures much higher frequencies.

The present invention preferably comprises a MHD ARS, preferably mounted on a turntable (preferably ultra small) so that its sensitive axis is substantially parallel to the turntable, and rotated preferably at a constant rate. The turntable preferably comprises slip rings that bring in power to operate the MHD ARS and associated electronics, such as a low-power micro-controller (or ADC) with the sensor on the spinning platform. Running an ultra small turntable at a constant rate (for example 30 rev/s) typically requires little power based on a low-friction turntable design. The small form factor version of the present invention shown in FIG. 4 may be reduced in size and weight by, for example further miniaturization of the control and processing electronics. As used throughout the specification and claims, the term “turntable” means a rotating platform, spindle, shaft, or any other rotating device.

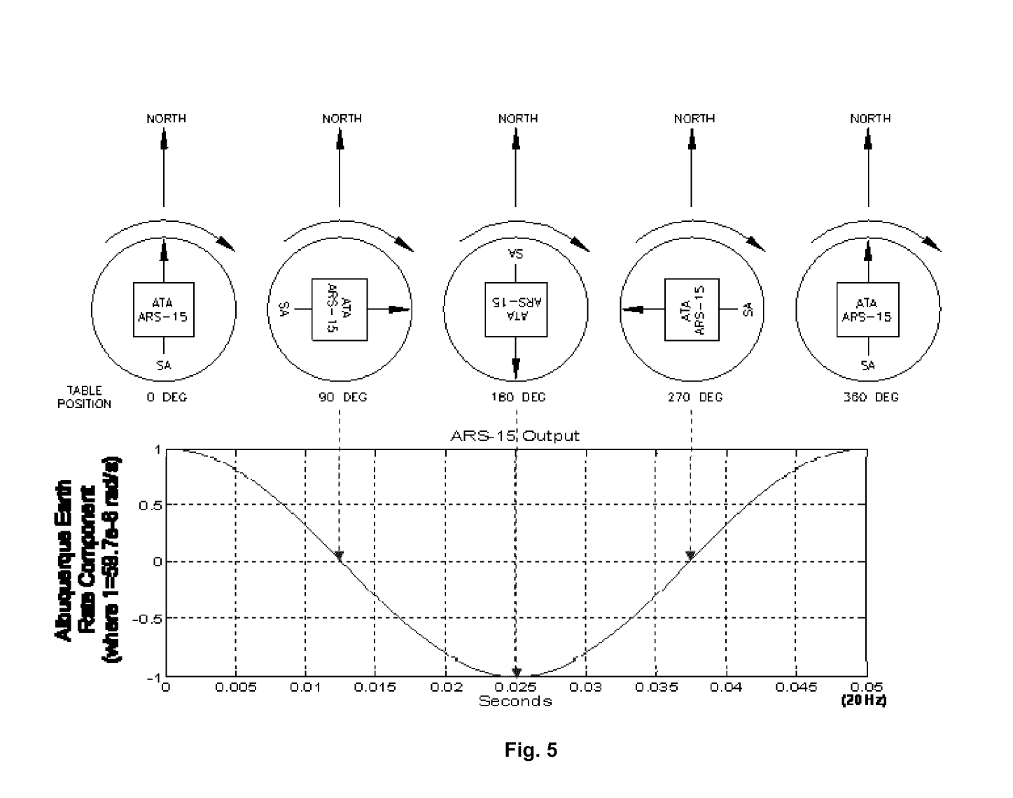

FIG. 5 depicts the basic operation of the present invention over one cycle of rotation. The MHD ARS-15 is preferably rotated at a constant rate on a turntable placed substantially horizontally (i.e. the plane of rotation is preferably approximately normal to the gravity vector, or the axis of rotation is approximately parallel to the gravity vector). The turntable is preferably equipped with an absolute (indexed) encoder to provide absolute table angle relative to the case or a desired direction. FIG. 5 shows an example where the zero angle of the table angle is pointing north. In this example, the zero crossings of the ARS output occur when the sensor is pointing East (90 deg) and West (270 deg). The maximum output signal occurs when the MHD ARS sense axis substantially aligns with the horizontal component of the earth's spin rate (north). The minimum output signal occurs when it is substantially aligned with south. In this case, the azimuth of the direction indicated by the zero angle of the table equals zero.

The MHD ARS samples the Earth's spin vector at the frequency of the turntable spin rate (revolutions per second=Hz). The MHD ARS spinning on the turntable at a constant rate thus effectively “modulates” earth rate at the spin rate of the turntable. Demodulating the MHD ARS signal and only using the phase information relative to the sine of the angle of the turntable versus time enables determination of north with respect to the turntable encoder angle. The angle from north to the “zero” angle index of the table is the azimuth angle of interest. In other words, to find the azimuth of any desired direction, the zero angle of the table is chosen to be that direction. The sensor output is a maximum when it is pointing north. The angle of the turntable when this maximum occurs, relative to the zero angle, is the azimuth of the desired direction.

The phase of the modulated Earth rate signal relative to the angular position of the turntable encoder angle can also be determined by simply knowing the encoder angle at the zero crossings of the Earth rate signal. The FIG. 5 example indicates that the “zero” angle of the turntable encoder is aligned with True North such that the zero crossings of the modulated Earth rate signal occur at 90 degrees (East) and 270 degrees (West). Zero crossings are easier to measure than the maximum of the ARS output, which occurs at True North; however, True North is easily calculated for this measurement because it is 90 degrees from the zero crossing angles. True North, and thus azimuth, of the direction can thus be determined by knowing the turntable encoder angle at the Earth rate zero crossings.

Because the ARS cannot measure a static angular rate, data is preferably collected as the turntable is rotating (so there is output from the ARS). Any analog or digital data collection device (i.e. data collector) may be used.

The present invention can preferably perform precision azimuth measurement (better than 10 meters in 3000 m, equivalent to 3 milliradians or 0.17 degrees) with rapid acquisition time (less than 1 minute to achieve 1 milliradian, or alternatively less than 0.1 degree, azimuth accuracy) with respect to accuracy, size, weight, and power (SWaP), and can be volume produced at relatively low cost.

### Simulations

A simulation was setup so that the input axes of the MHD ARS are rotated about an axis perpendicular to the horizontal component of the Earth rotation rate vector. Hence, the rotating sensors see an input which is a sinusoidal projection of the Earth rotation rate horizontal component (59.57 microrads/s at latitude of 35 degrees). The present invention was to compute an azimuth angle at the location of Albuquerque, N. Mex. (latitude of 35 degrees) with a turntable spin rate of 30 revolutions/second (30 Hz). Various algorithms can be used to calculate the phase angle between the measured horizontal Earth rate and the orientation of the rotating sensor assembly as measured by the turntable encoder or resolver. The north spin vector was estimated to be measured with the ARS-15 to better than 3 mrad (0.17 deg) within a 60 second time frame. 3 mrad (1σ) azimuth accuracy is equivalent to 10 m horizontal error at 3000 m range. Similar to the Allan variance measurement commonly applied to measure rate uncertainty in gyroscopes, the predicted azimuth uncertainty of the present invention based on the angle from the Earth's spin vector would improve over time (i.e., 3-5 minutes) to better than 0.05 deg.

Table 1 shows estimated performance parameters of the present invention. It is expected that the unit could be reduced in size to 40 cc (2.44 cu. in.) or lower by using a custom MHD sensor.

TABLE 1

| | |
|---|---|
| | AzMU Goals |
| Parameter | (ARS-15 Based) |

Dynamic Performance

| | | |
|---|---|---|
| Azimuth Accuracy | 1 | mrad (0.05 deg) |
| Measurement Time (Acquisition Time) | <1 | min |

Mechanical

| | | |
|---|---|---|
| Size | ~130 | cc (8.0 cu. in.) |
| Weight | <250 | grams |

Electrical

| | | |
|---|---|---|
| Voltage Input | 3 | V |
| Power | <120 | mW |
| Energy | 3.1e4 | Joules |

Environmental

| | |
|---|---|
| Operating Temperature | −35° C. to +85° C. |
| Survival Temperature | −60° C. to +100° C. |

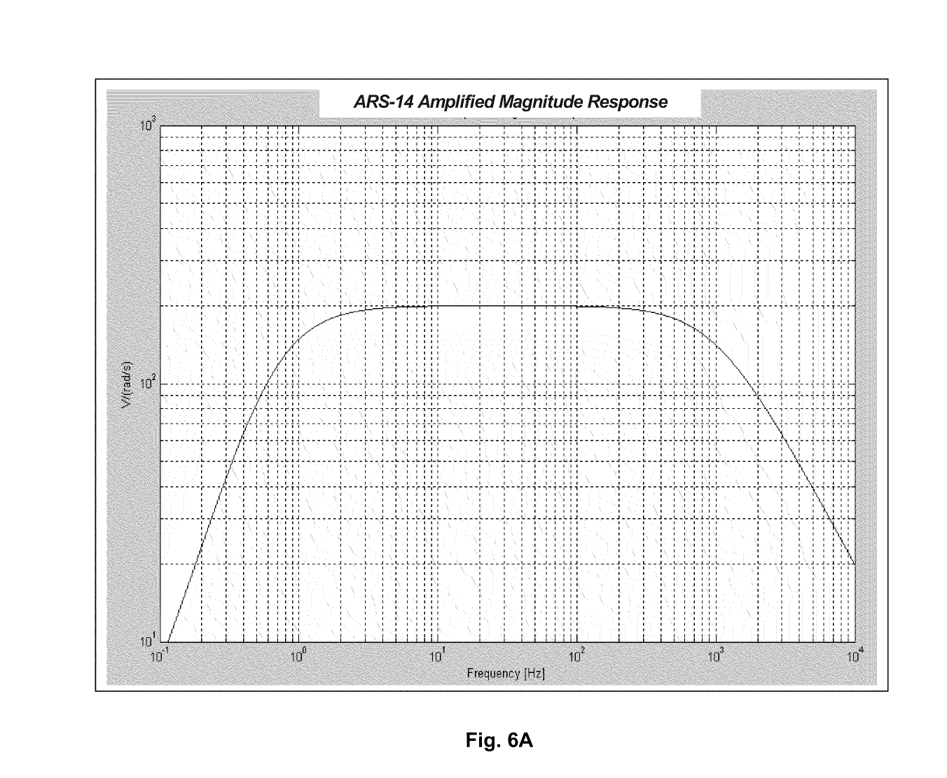

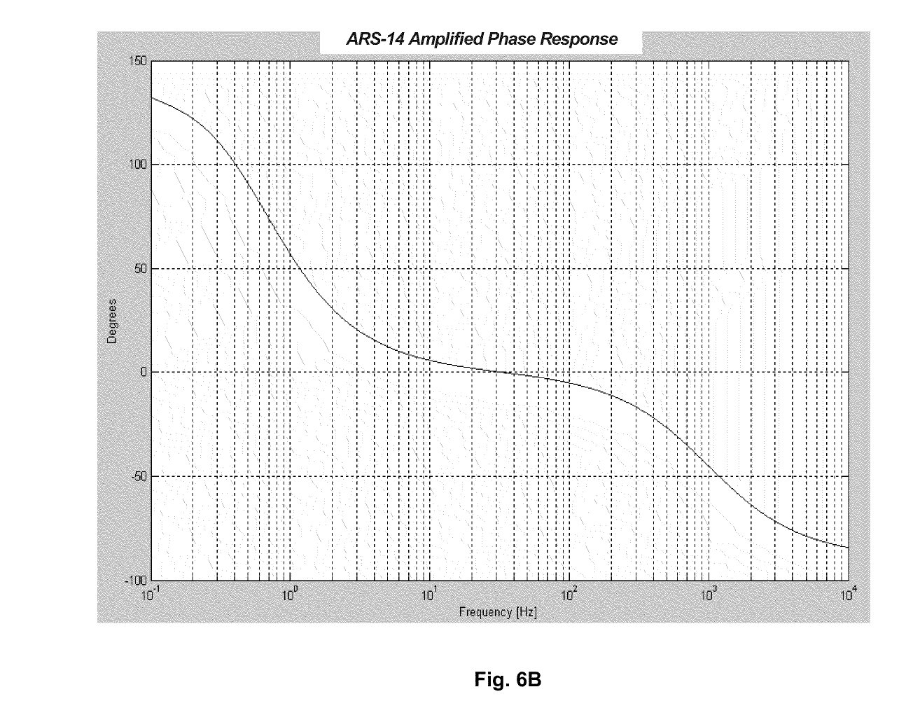

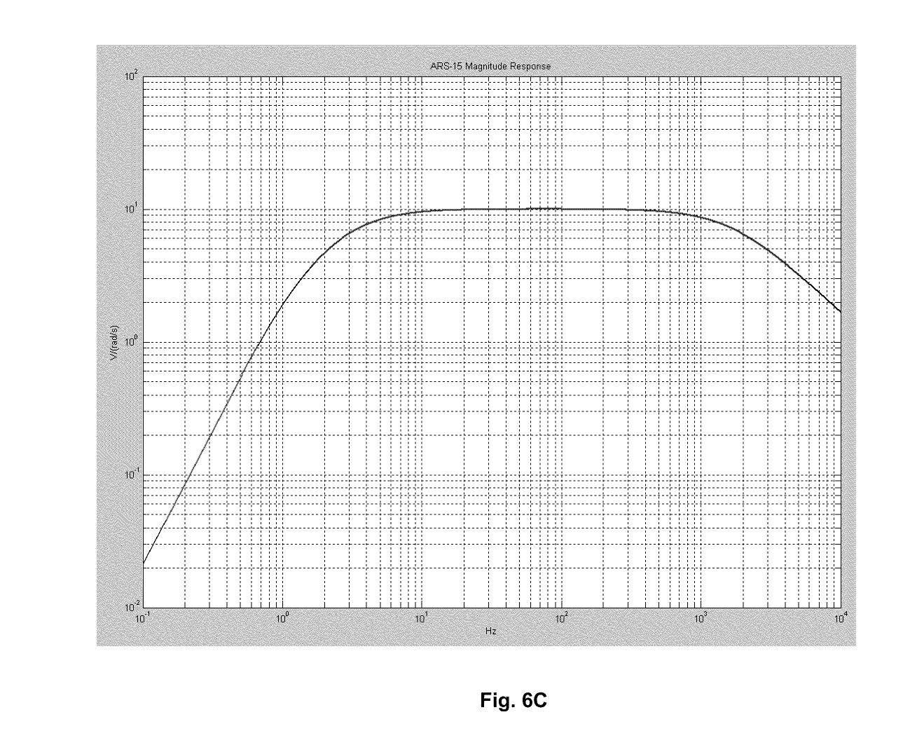

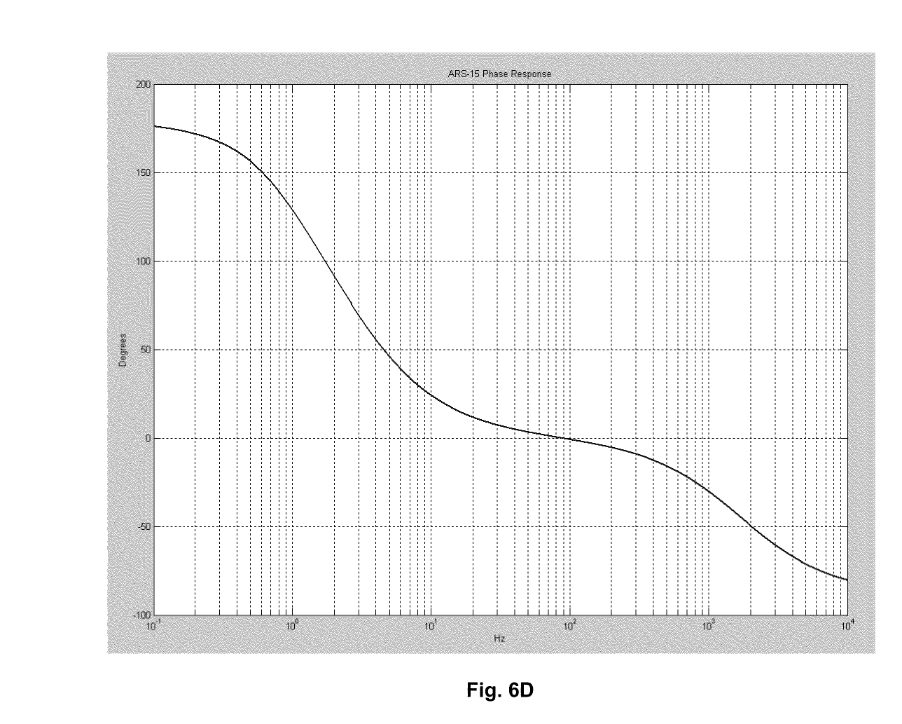

FIGS. 6A-6D show typical frequency (magnitude and phase) response models for the ARS-14 and ARS-15. The magnitude response is based on the standard gain setting for the sensors but can be easily increased to much higher sensitivity (scale factor) for operation of the present invention. For example, the ARS-15 gain may be increased as high as possible to enable azimuth measurement operation without saturation. In addition, the bandwidth may be set to a much lower value, i.e. 10-20 Hz, to remove high frequency noise. Alternatively, a much lower bandwidth sensor can be used since the maximum turntable spin frequency is anticipated to be below 20 Hz. The optimal SF and LPF cutoff frequency and rolloff (−40 to −60 dB/decade minimum) will be optimized.

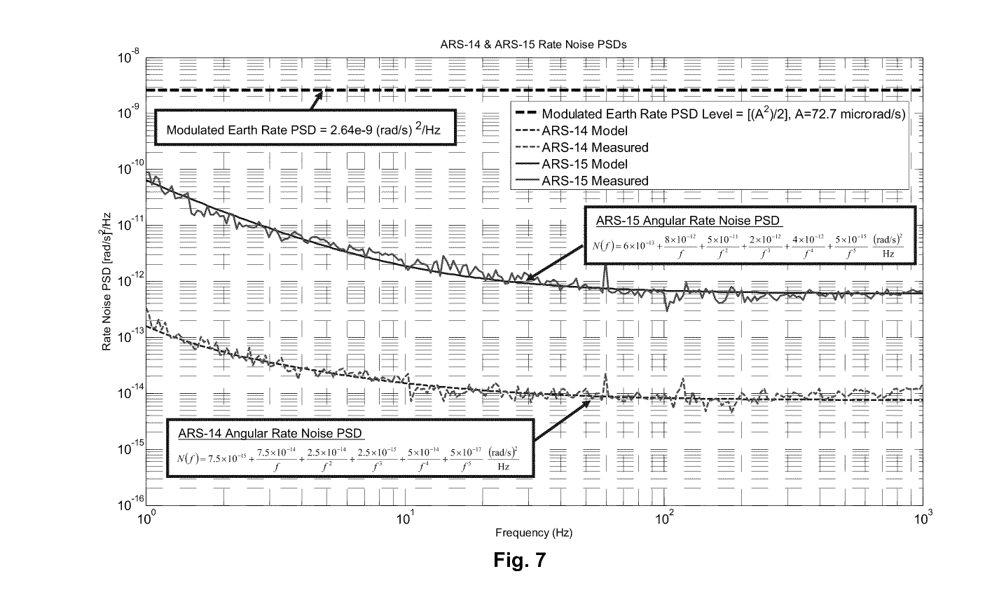

The angular noise rate was also simulated. FIG. 7 illustrates the margin between the Modulated Earth Rate Signal and the Rate Noise Power Spectral Densities (PSDs) of the ARS-15 and the ARS-14. The lower the ARS rate noise PSD, the better the effective signal to noise (SNR) ratio of the Earth rate signal to the inherent sensor noise. A conservative initial analysis, at 30 rev/sec (i.e., 30 Hz) and at a latitude of 35 degrees (Albuquerque, N. Mex.), suggests that the ARS-14 and ARS-15 provide a SNR of 52 dB and 32 dB, respectively with respect to the horizontal (azimuth) Earth rate signal at 35 degrees latitude (Ω_{E}=7.27e-5 cos(35°)=59.6e-6 rad/s).

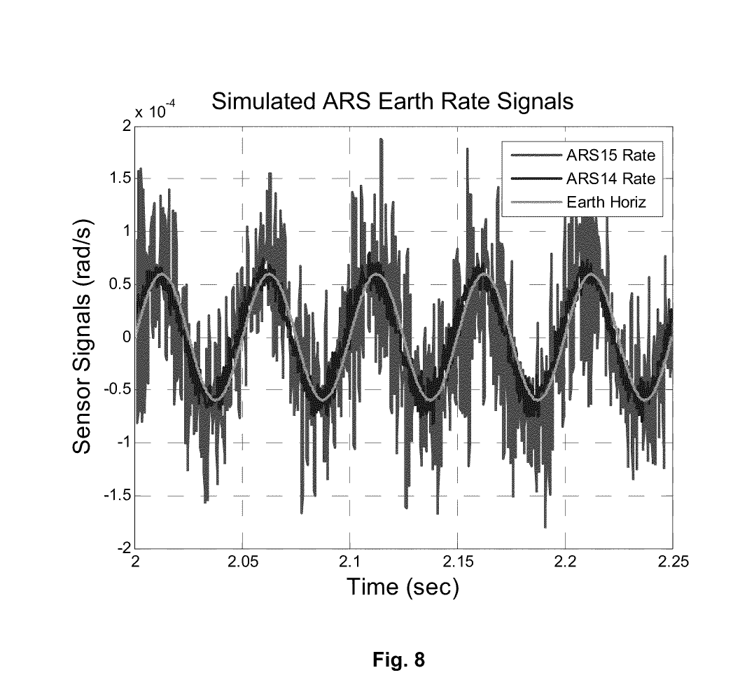

FIG. 8 plots the time histories of the simulated ARS-14 and ARS-15 sensor output signals scaled to angular rate and overlaid on the horizontal Earth rate signal, or “ground truth”, for comparison. The ARS-14, shown in blue, depicts significantly less noise than the ARS-15, shown in red. This is because the ARS-15 equivalent rate noise PSD is more than an order of magnitude noisier than the ARS-14. The horizontal Earth rate signal, shown in green, is overlaid to illustrate how well the ARS-14 and ARS-15 sensors can measure Earth rate that is modulated at the spin frequency of the turntable. These models are based on the broadband performance of the ARSs with the standard upper cutoff frequency of 1 kHz. Band pass filtering at the turntable spin frequency preferably results in very high fidelity Earth rate measurements suitable for high accuracy azimuth measurement.

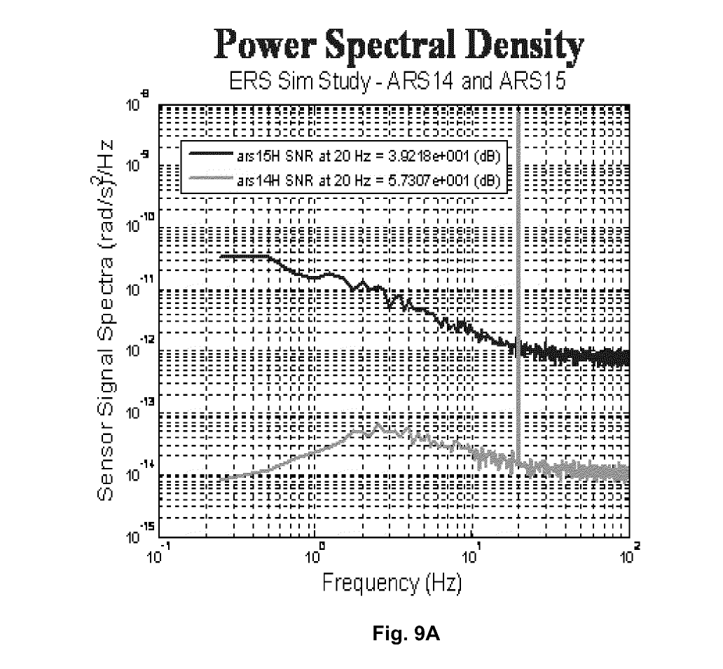

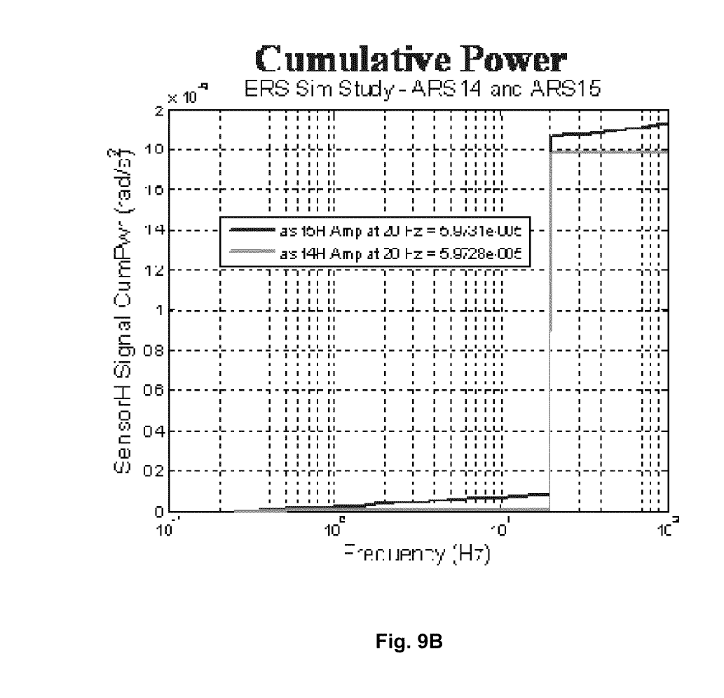

FIG. 9A shows the Earth rate induced signal component at a 20 Hz turntable rotation rate with respect to the Equivalent Rate Noise PSD of the ARS-15 and the ARS-14. FIG. 9B is the rms rate cumulative power forward sum which emphasizes the contribution of the Earth rate signal at 20 Hz.

### Azimuth Phase Calculation

The calculation of true (inertial) north or azimuth based on the ARS-14 and ARS-15 signal outputs typically requires accurate detection of the phase of the ARS Earth rate signal with respect to the angular position of the turntable, preferably measured using an absolute (indexed) encoder or resolver. Various azimuth calculation algorithms for azimuth determination may be employed, including but not limited to zero cross phase detection, fast fourier transform (FFT) phase detection, least mean square (LMS) recursive sine fit, heterodyne phase demodulation (encoder sine and cosine multiply), and dual-tree complex wavelet transform (CWT). In general, the best algorithms are the ones that minimize azimuth measurement uncertainty in the least amount of time. Ultimately, a combination of the various algorithms implemented in a parallel fashion is anticipated to yield the highest accuracy with minimal acquisition time.

### Zero Crossing Azimuth Calculation

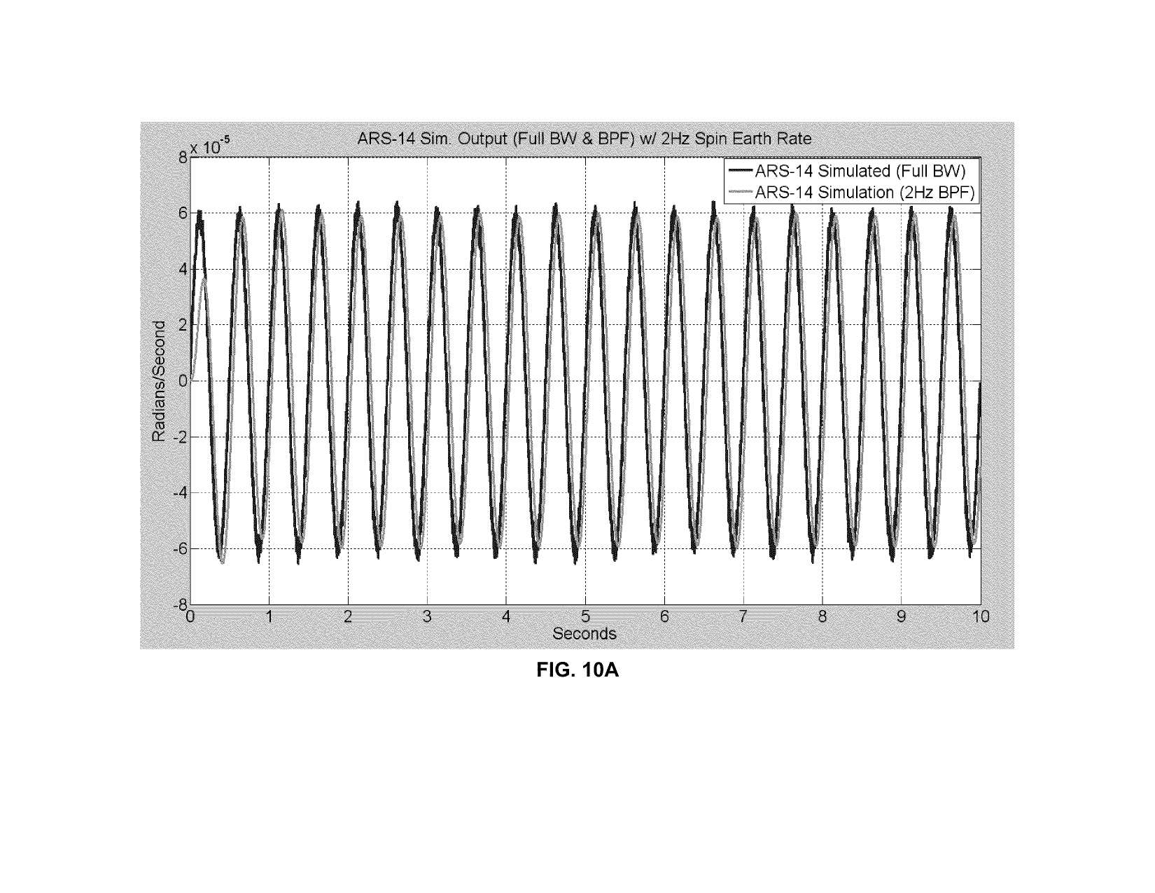

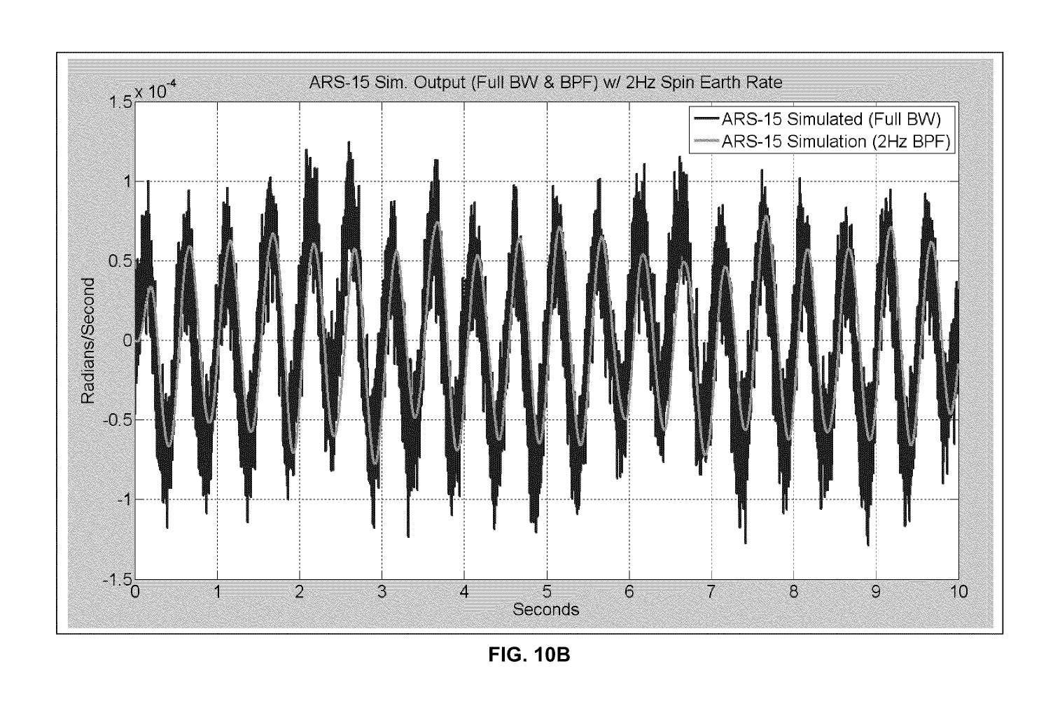

The simplest algorithm to calculate azimuth using the MHD ARS Earth rate signal is to detect the zero crossing times. The turntable angle versus time is preferably synchronously recorded with the ARS output signal. The ARS zero crossing times with respect to the turntable angle is easily implemented in either hardware or software, and is less susceptible to phase error than, for example, measuring the maximum of the signal. The ARS Earth rate signals shown in FIGS. 10A and 10B are based on the broadband noise characteristic of the ARS-14 and ARS-15 at 2 Hz. The zero crossing methodology to calculate azimuth is preferably optimized by band-passing the ARS signal at the spin frequency of the turntable before the zero cross detection algorithm is applied. Band-passing removes the ARS output voltage bias while simultaneously removing the broadband noise, thus yielding a signal optimized for zero crossing time detection.

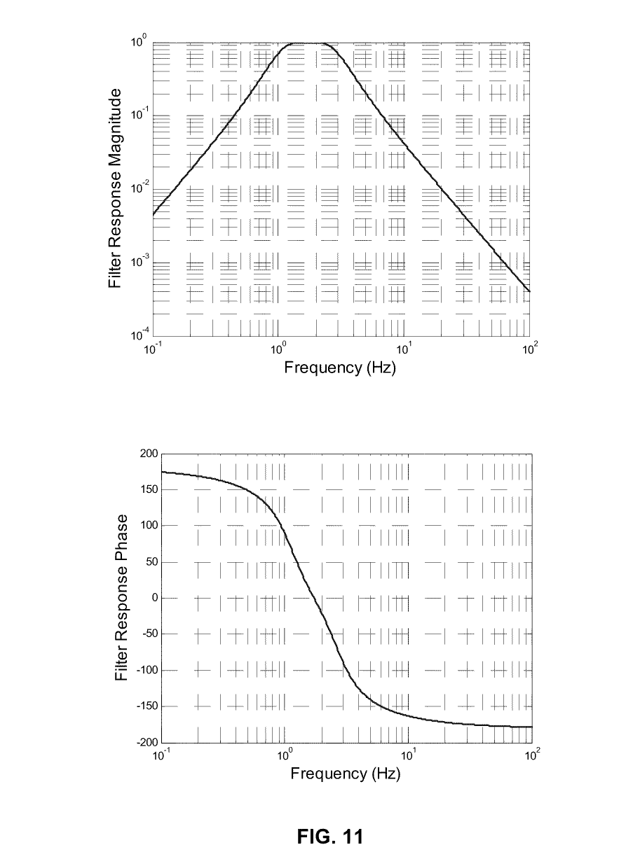

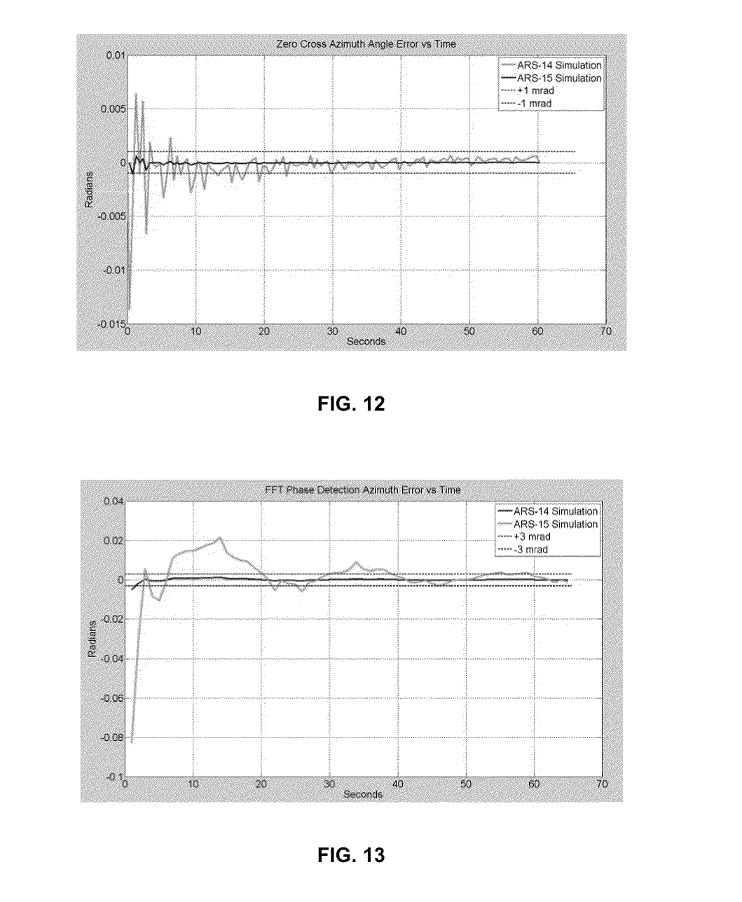

FIG. 11 is a digital band-pass filter (BPF) at the turntable spin frequency (2 Hz) that is used to preprocess the ARS simulated output signal prior to zero cross detection. FIG. 11 clearly illustrates the effect of the band-pass filter to effectively isolate the modulated Earth rate signal. Azimuth angle error was calculated by using both positive and negative slope zero crossing times relative to the encoder angle at the zero crossing times to accurately derive azimuth angle. The ARS-14 and ARS-15 voltage output signals were digitized with 24 bit digitization at 10 kHz. The turntable position encoder is also synchronously sampled at 10 kHz with an encoder angle resolution of 0.0001 degrees (0.001745 mrad). FIG. 12 shows zero crossing results for simulated ARS-14 and ARS-15 signals which are band-pass filtered at 2 Hz. The azimuth calculation error based on the simple zero cross algorithm for a constant turntable spin frequency of 2 Hz (720 deg/s) shows good convergence to less than 1 mrad in 30 seconds for both the ARS-14 and the ARS-15. Zero cross phase detection after band-passing the ARS-14 and ARS-15 signals, preferably at the turntable spin rate, is the simplest algorithm to implement for real time operation. The band pass filter is preferably centered on the turntable frequency.

### Fast Fourier Transform (FFT) Azimuth Calculation

Another method evaluated for azimuth detection using the ARS Earth rate signal and the turntable position versus time is based on the Fast Fourier Transform (FFT). The FFT is used to calculate a transfer function (TF) between the sine of the encoder angle with respect to time and the ARS output signal with respect to time. The TF phase angle at the turntable spin frequency and the known phase response of the MHD ARS at the spin frequency of the table enables precision calculation of azimuth angle. FIG. 13 shows the estimated azimuth measurement error versus acquisition time based on the ARS-14 and ARS-15 simulated outputs at a 2 Hz spin rate. The computed azimuth error versus time based on the ARS-14 and ARS-15 indicates exceptional azimuth measurement accuracy versus acquisition time. The ARS-15 converges to around 3 mrad in less than 60 seconds, and the ARS-14 converges to less than 1 mrad in tens of seconds. The ARS-14 will outperform the ARS-15 in azimuth measurement because the ARS-14 exhibits an order of magnitude better resolution than the ARS-15. The standard deviation of the azimuth error (for the 32 sec to 64 sec time interval) based on the ARS-15 is 0.035 deg (0.6 mrad) rms and that of the ARS-14 is 0.004 deg (0.07 mrad) rms. More sophisticated and optimized estimators could potentially yield faster convergence (acquisition time) and improved azimuth angle accuracy. Although more complex than the zero-crossing algorithm, the FFT algorithm is the most accurate, and can be implemented in real time in a low power microcontroller, digital signal processor (possibly embedded), or FPGA.

Clockwise (CW) and Counterclockwise (CCW) Azimuth Calculation to Remove the MHD ARS Phase from the Azimuth Calculation

The MHD ARS phase response can be effectively removed from the azimuth calculations, thus requiring no a priori knowledge of the MHD ARS phase response at the spin frequency of the turntable. This is because of the unvarying and common Earth Rate Rotation Vector reference. The methodology is based on calculating the phase between the ARS and the sine (or cosine) of the angular position of the turntable and the MHD ARS for a clockwise (CW) rotation direction of the turntable at a constant spin rate and for then repeat the same calculation with the table spinning at a constant rate in the counterclockwise rotation (CCW) of the turntable. The CW phase result is then added to the CCW phase result and then divided by two thus yielding the azimuth direction of interest with respect to the turntable encoder angle. The CW and subsequent CCW phase calculation enables the effective removal of the phase contribution of the MHD ARS and leaves the desired azimuth direction with respect to the turntable position. The azimuth is calculated by simply adding the CW and CCW results for each pair which effectively subtracts or cancels the MHD ARS Phase without any prior knowledge of the MHD ARS phase. The calculation can also be performed starting with the CCW first and CW next. Also, the absolute azimuth error is further reduced as more CW/CCW azimuth calculation pairs are averaged with respect to time.

### Example

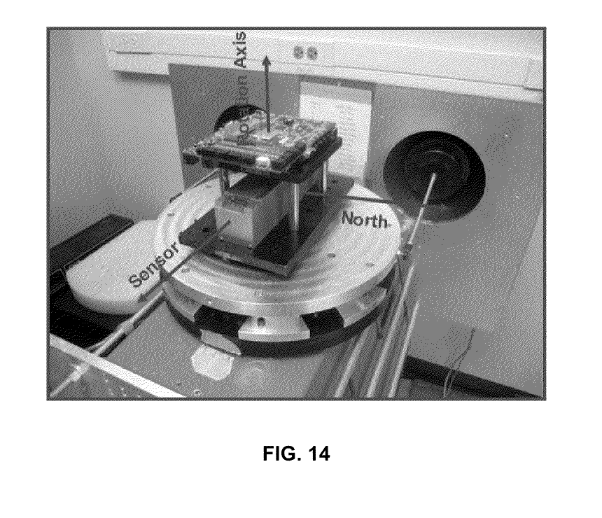

A prototype azimuth detector of the present invention was constructed based on ATA's Ideal Aerosmith 1601-4 single axis precision rate table, which has a position repeatability of 0.2 arcseconds (1 urad), on which two ARS-14 MHD angular rate sensors were mounted back to back. Using more than one sensor improves the signal to noise ratio of the signal. FIG. 14 is a photograph of the prototype showing the back to back location of the two ARS-14 sensors that house the ARS-14 MHD sensors. The sensitive axes of the ARS-14s are parallel to the rate table platform. The amplitude of the horizontal component of the Earth rate spin vector that is measured by the ARS-14s is based on the cosine of the latitude:

Earth Rate_horizontal comp=Earth_rate*Cos(Lat),

where Earth_rate=72.8e-6 rad/s (4.1666e-3 deg/s), and Lat is the latitude of ATA's laboratory in Albuquerque, N. Mex.=35 degrees. Thus,

Earth Rate_{—}H=59.6e-6 rad/s(3.83e-3 deg/s)

The best performance of the prototype was with a rotation frequency of 2 Hz, or 720 deg/s. Data was collected at 2 kHz and 18 bits over +/−5V input using a National Instruments Data Acquisition

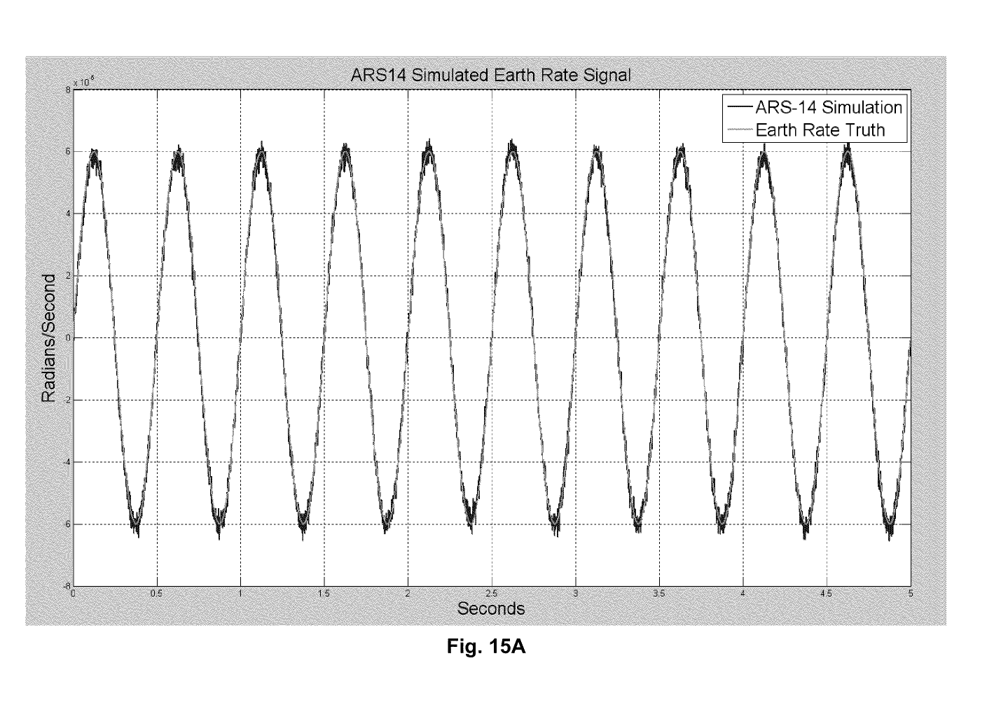

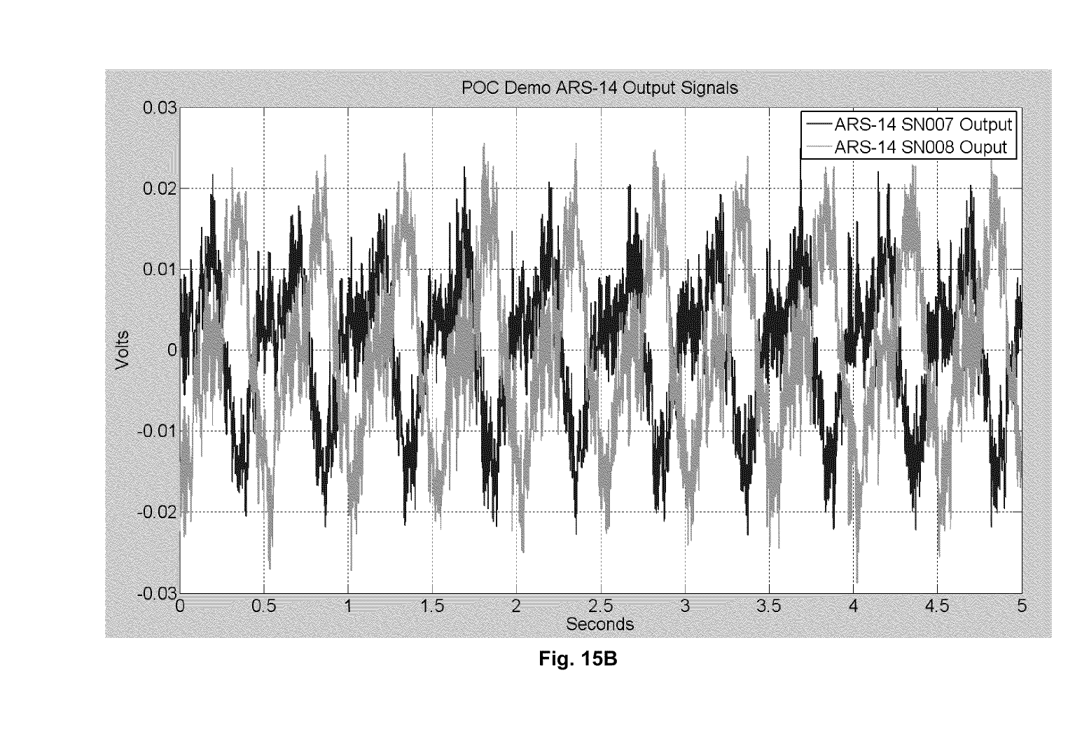

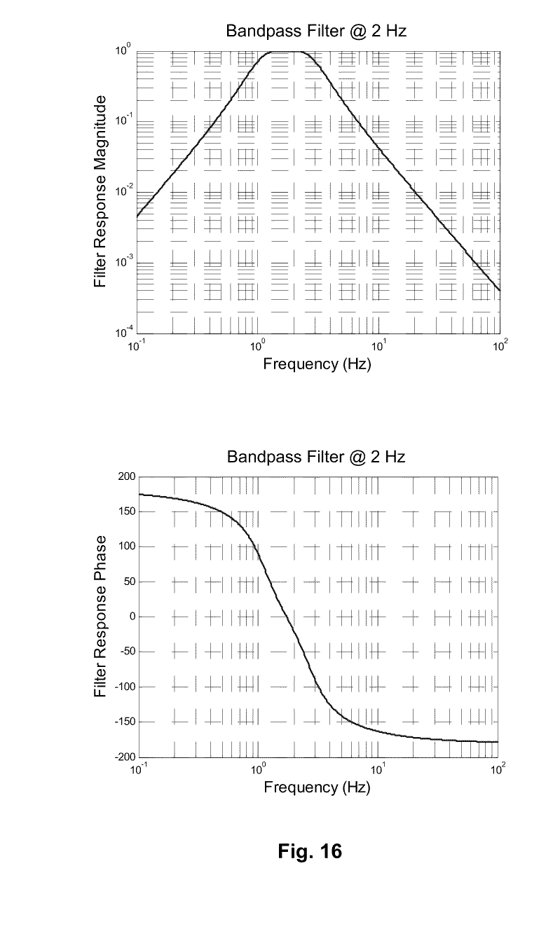

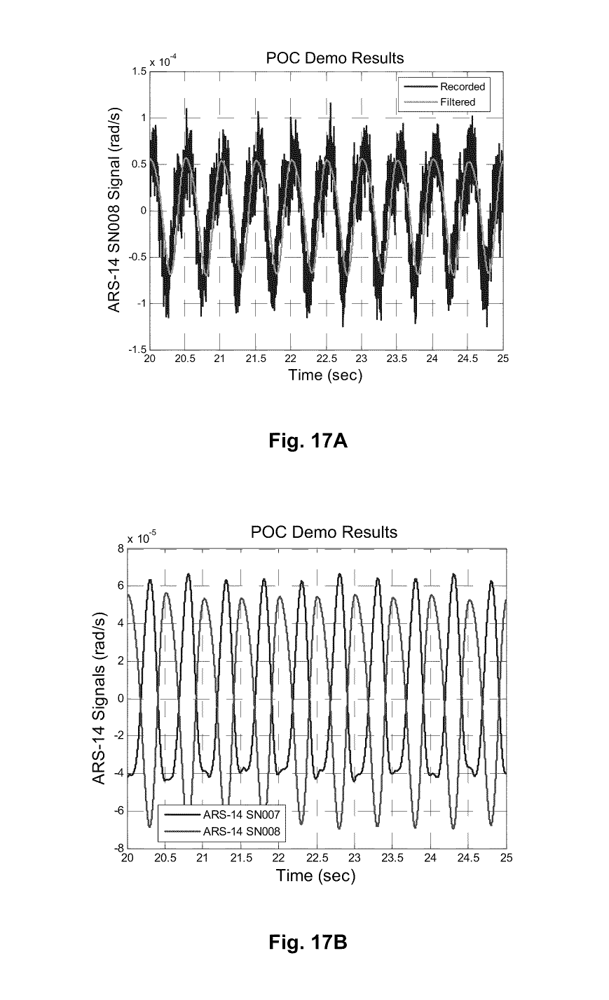

System. FIG. 15A is the simulated ARS-14 signal scaled to angular rate with the Earth rate signal superimposed for a 2 Hz turntable rate, and FIG. 15B plots the measured POC Demonstrator ARS-14 voltage output signals (SN007 and SN008) with the turntable spin rate at 2 Hz. FIG. 16 is the digital bandpass filter that was used to preprocess the ARS-14 signals prior to Zero Cross Phase Detection. FIG. 17A shows the ARS-14 SN008 signal before (blue) and after (green) the 2 Hz bandpass filter, and FIG. 17B shows the back to back ARS-14s SNs 007 and 008 after band-pass filtering.

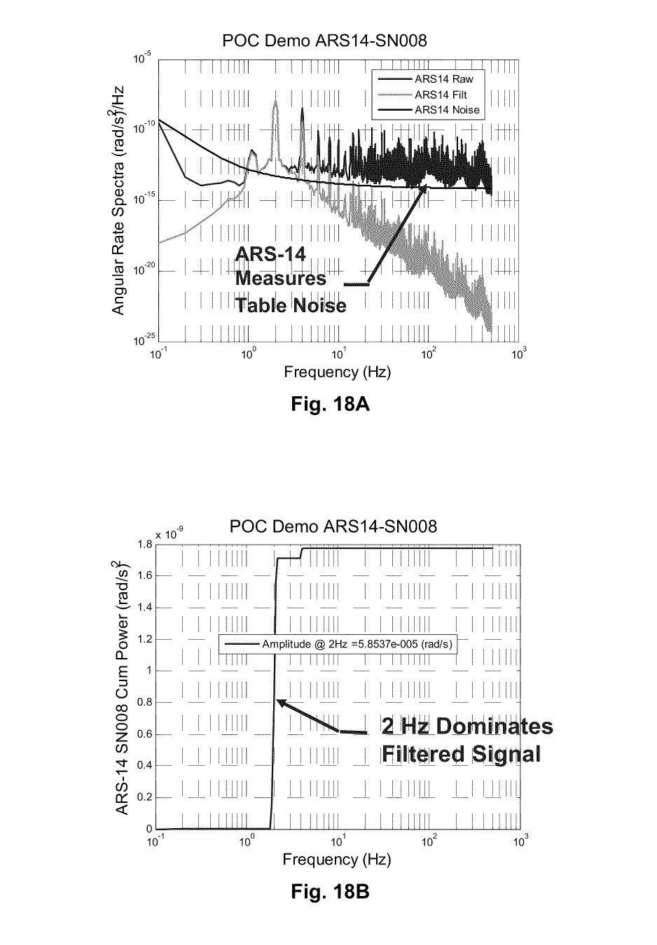

FIG. 18A shows the rate PSD before filtering (blue curve) and after filtering (green curve) with the aforementioned digital bandpass filter. FIG. 18B shows the cumulative forward sum (power) that illustrates the Earth rate signal contribution with respect to the background noise for the ARS-14 SN 008, as indicated by the step at the 2 Hz spin frequency. This shows that the earth rate signal is significantly larger than noise contribution thus enabling accurate azimuth detection.

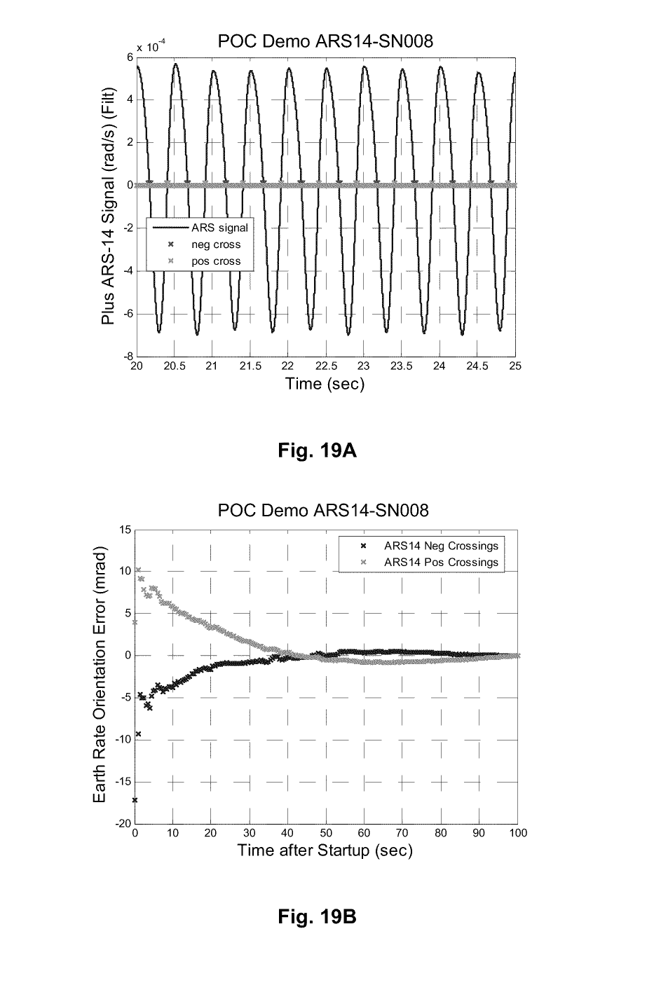

FIG. 19A shows the Zero Cross Detection results using the prototype ARS-14 SN008 signal after 2 Hz bandpass filtering according to FIG. 16. FIG. 19B depicts the relative azimuth error via averaging the zero cross times for both positive slope zero crossings (green curve) and negative slope zero cross (blue curve). The results approach 1 mrad after about 30 seconds.

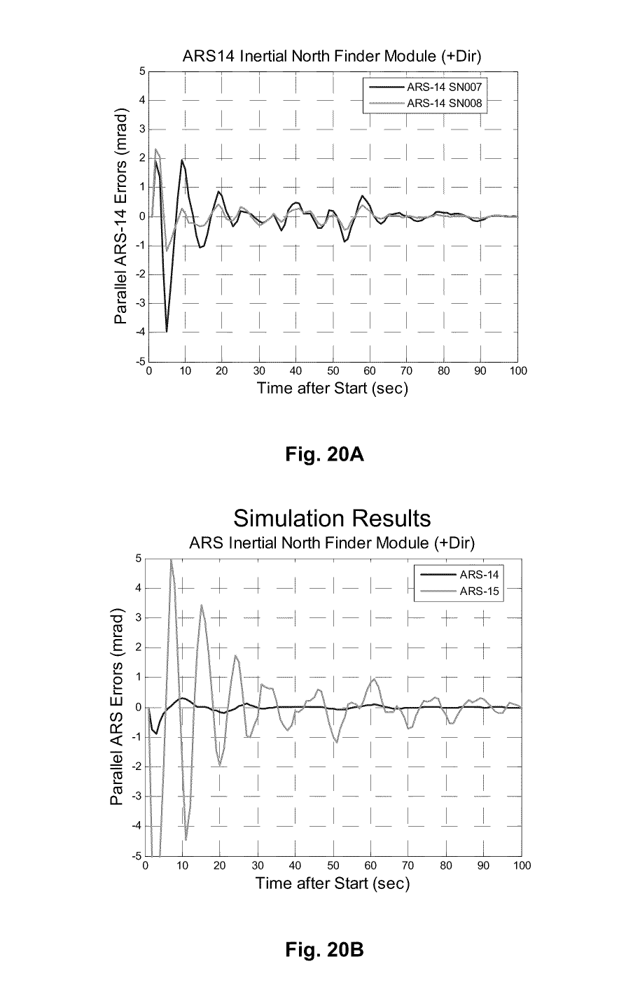

The two ARS-14s used in the prototype unit (SN 007 and SN 008) were processed to determine the azimuth error using the FFT Phase Detection algorithm (FIG. 20A) and compared to the simulation predictions for the ARS-14 and the ARS-15 (FIG. 20B). The actual prototype measurements shown in FIG. 20A are higher than the ARS-14 simulated output, in part due to the additional bearing noise that is much higher than the inherent ARS-14 rate noise PSD. The simulated ARS-14 and ARS-15 signals, as well as the measured ARS-14s SN007 and SN008, all indicate less than 1 mrad azimuth measurement capability in less than 30 seconds.

In summary, the prototype using the ARS-14s was capable of 1 mrad azimuth measurement based on the phase stability of the 60 second interval and the relatively high SNR to the Earth rate signal. The ARS-15 simulation estimates indicate 1 mrad performance with longer acquisition times than the ARS-14. The expected specifications for NFMs, NSMs, or MNSMs (Miniature North Seeking Modules) of the present invention are presented in Table 2.

TABLE 2

| | ARS-14 | | ARS-15 | |
|---|---|---|---|---|
| PARAMETER | BASED NSM | | BASED MNSM | |
| Accuracy | 0.0057° | | 0.057° | |
| | 0.1 | mrad | 1 | mrad |
| | 0.00635 | gon (grad) | 0.0635 | gon (grad) |
| Azimuth Acquisition Time | <1 | minute | <1 | minute |
| Length, Width, or Height | <4.0″ (10.16 cm) | | <2.5″ (6.35 cm) | |
| Weight | <1 | kg | <0.5 | kg |
| Power | <2 | W | <2 | W |

| | | |
|---|---|---|
| Operating Temperature | −40 to +85 C. | −40 to +85 C |

In other embodiments of the present invention, more than one ARS may be used at the same time on the same turntable. This can provide reduced noise and higher accuracy, for example through the use of differential noise reduction.

In other embodiments of the present invention, the turntable base may be oriented at a right angle (e.g. turntable base oriented vertically instead of horizontally) to the orientation described above, which enables the measurement of latitude. Latitude measurement requires that the azimuth angle with respect to the vertical turntable is also known.

The present invention has many commercial applications, such as in the automotive, aviation, nautical, manufacturing, and law enforcement fields, particularly, for example, man-portable systems where weight and power consumption are critical. One example is survey applications inside buildings, mines, tunnels, and others where the alternative methods of azimuth measurement simply do not apply. Another possibility is directional drilling, where a high temperature version of the present invention might have significant commercial applications. Directional drilling to recover oil and natural gas in deeper and more complex reservoir structures will require even better azimuth measurement for “navigating” the directional drill. The present invention is particularly useful for any application in which the NSM needs to operate accurately in varying magnetic fields, such as those created by nearby weapon systems, generators, vehicles and other ferrous objects. The present invention is also useful for military applications that require precision azimuth knowledge.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. An apparatus for measuring azimuth, the apparatus comprising:
an angular rate sensor disposed on a turntable; and
a data collector for collecting an output from said angular rate sensor while said turntable is rotating.

2. The apparatus of claim 1 wherein a sensitive axis of said angular rate sensor is substantially parallel to said plane of rotation.

3. The apparatus of claim 1 wherein said turntable rotates at a substantially constant rotation rate.

4. The apparatus of claim 3 wherein said rotation rate is between approximately 0.5 Hz and approximately 30 Hz.

5. The apparatus of claim 1 wherein said turntable comprises an encoder for providing an angle of rotation of said turntable relative to a turntable base.

6. The apparatus of claim 1 wherein a size of said apparatus is less than approximately 200 cc.

7. The apparatus of claim 6 wherein a size of said apparatus is less than approximately 150 cc.

8. The apparatus of claim 1 wherein a weight of said apparatus is less than approximately 1 kg.

9. The apparatus of claim 8 wherein a weight of said apparatus is less than approximately 500 g.

10. The apparatus of claim 9 wherein a weight of said apparatus is less than approximately 250 g.

11. The apparatus of claim 1 comprising two or more angular rate sensors.

12. The apparatus of claim 1 wherein said turntable is oriented so that its plane of rotation is approximately normal to a gravity vector or its axis of rotation is parallel to a gravity vector.

13. A method for detecting azimuth, the method comprising the steps of:
selecting a zero angle of a turntable to be coincident with a desired direction;
rotating an angular rate sensor on the turntable;
collecting an output signal from the sensor while the sensor is rotating;
measuring an angle of rotation of the turntable relative to the zero angle; and
calculating the azimuth of the desired direction.

14. The method of claim 13 wherein the rotating step comprising rotating the angular rate sensor at a substantially constant rotation rate.

15. The method of claim 14 wherein the rotation rate is between approximately 0.5 Hz and approximately 30 Hz.

16. The method of claim 13 wherein the calculating step comprises correlating the angle of rotation to a characteristic of the output signal.

17. The method of claim 16 wherein the characteristic is selected from the group consisting of phase, maximum, minimum and zero crossing point.

18. The method of claim 17 further comprising the step of applying a bandpass filter to the output signal prior to detecting the zero crossing points.

19. The method of claim 18 wherein the bandpass filter cutoff frequency is approximately a rotation rate of the turntable.

20. The method of claim 13 wherein the calculating step comprises applying a Fast Fourier Transform to the output signal.

21. The method of claim 13 wherein the rotating step comprises rotating the angular rate sensor clockwise at a constant rotation rate and counterclockwise at the same constant rotation rate.

22. The method of claim 21 further comprising adding a clockwise output signal phase to a counterclockwise output signal phase.

23. The method of claim 13 wherein the azimuth is detected with an accuracy of less than approximately 1 mrad in less than approximately one minute from beginning the rotating step.

24. The method of claim 23 wherein the azimuth is detected with an accuracy of less than approximately 0.1 mrad in less than approximately one minute from beginning the rotating step.
